(19) United States
(12) Patent Application Publication
(10) Pub. No.: US 2026/0034903 A1
(43) Pub. Date: Feb. 5, 2026

(54) POWER CONVERTER, METHOD FOR CONTROLLING POWER CONVERTER, BATTERY CHARGER, AND VEHICLE

(71) Applicant: GS Yuasa International Ltd., Kyoto-shi (JP)

(72) Inventor: Akiteru CHIBA, Kyoto-shi (JP)

(21) Appl. No.: 19/354,972

(22) Filed: Oct. 10, 2025

Related U.S. Application Data
(63) Continuation of application No. PCT/JP2024/014075, filed on Apr. 5, 2024.

(30) Foreign Application Priority Data
Apr. 11, 2023 (JP) 2023-064166

(51) Int. Cl. B60L 53/20; H02M 1/00; H02M 3/00; H02M 3/335

(52) U.S. Cl. CPC B60L 53/20; H02M 1/0077; H02M 3/01; H02M 3/33571

(57) ABSTRACT

A power converter converts a direct-current voltage into an output voltage by a switching operation of an upper switch and a lower switch using an LLC circuit including a resonant inductor connected to a connection point between the upper switch and the lower switch connected in series between a positive electrode and a negative electrode of the direct-current voltage, a primary winding of a transformer, and a resonant capacitor. The power converter includes an LLC circuit of each of a plurality of stages in which secondary windings of the transformers are connected in series, and a controller configured or programmed to form a series resonant circuit of the resonant inductor and the resonant capacitor in any one or more of the LLC circuits of the plurality of stages and cause another of the LLC circuits to perform the switching operation.

### CROSS REFERENCE TO RELATED APPLICATIONS

This application claims the benefit of priority to Japanese Patent Application No. 2023-064166 filed on Apr. 11, 2023 and is a Continuation Application of PCT Application No. PCT/JP2024/014075 filed on Apr. 5, 2024. The entire contents of each application are hereby incorporated herein by reference.

### BACKGROUND OF THE INVENTION

### 1. Field of the Invention

The present invention relates to power converters to convert a direct-current voltage into a desired output voltage.

### 2. Description of the Related Art

A battery charger that charges a storage battery (battery) mounted on an electric vehicle or the like often adopts an efficient LLC circuit (resonant circuit) (see, for example, JP-A-2012-249375). The LLC circuit has an efficient input/output range, and the efficiency deteriorates significantly outside the input/output range.

### SUMMARY OF THE INVENTION

By providing a plurality of LLC circuits and switching outputs to parallel connection or series connection, the efficient input/output range can be obtained. A power converter 100 illustrated in FIGS. 11A and 11B include two half-bridge LLC converters (hereinafter, referred to as LLC circuits 200) and a changeover switch SW. The changeover switch SW switches the outputs of the two LLC circuits 200 to series connection or parallel connection. FIG. 11A illustrates a state in which the outputs of the two LLC circuits 200 are connected in parallel, and FIG. 11B illustrates a state in which the two outputs are connected in series.

An output voltage Vo of the LLC circuit 200 changes according to a switching frequency. FIG. 12 illustrates an example of output characteristics of the switching frequency and the output voltage Vo, in which the frequency greatly increases at a low-voltage output. The output characteristics of the two LLC circuits 200 are different between the case of parallel connection and the case of series connection. When an operating range (hereinafter, referred to as an operating frequency range) of the switching frequency is X11 to X12 (X11<X12), the output range of the output voltage Vo is V1 to V2 (V1>V2) in series connection, and V2 to V3 (Y2>Y3) in parallel connection. By switching between parallel connection and series connection at the output voltage Vo=V2 by the changeover switch SW, the output range of the output voltage Vo can be widened to V1 to V3 with respect to the operating frequency range X1 to X2.

However, since the changeover switch SW needs to be provided on the output side of the LLC circuit 200 to which a storage battery is connected, a surge current having large energy such as a storage battery short circuit due to a circuit failure may occur. Therefore, it is necessary to use a mechanical relay as the changeover switch SW, and a semiconductor switch cannot be used. The mechanical relay is expensive, large in size, and cannot be replaced by the semiconductor switch, which is inexpensive and small in size.

Example embodiments of the present invention provide power converters, methods for controlling power converters, battery chargers, and vehicles each capable of widening an output range of an output voltage with respect to an operating frequency range without providing a changeover switch on an output side.

A power converter according to an example embodiment of the present invention includes an LLC converter including an upper switch and a lower switch connected in series between a positive electrode and a negative electrode of a direct-current voltage. The LLC converter includes a resonant inductor connected to a connection point between the upper switch and the lower switch, a primary winding of a transformer, and a resonant capacitor. The power converter converts the direct-current voltage into an output voltage by a switching operation of the upper switch and the lower switch using the LLC converter. The power converter includes the LLC converter of each of a plurality of stages in which secondary windings of the transformers are connected in series. The power converter includes a controller configured or programmed to cause a series resonant circuit of the resonant inductor and the resonant capacitor to be formed in any one or more of the LLC converters of the plurality of stages and cause another of the LLC converters to perform the switching operation.

A method for controlling a power converter according to an example embodiment of the present invention is a method for controlling a power converter to convert a direct-current voltage into an output voltage by a switching operation of an LLC converter. The power converter includes the LLC converter including an upper switch and a lower switch connected in series between a positive electrode and a negative electrode of the direct-current voltage. The LLC converter includes a resonant inductor connected to a connection point between the upper switch and the lower switch, a primary winding of a transformer, and a resonant capacitor. The power converter converts the direct-current voltage into the output voltage by a switching operation of the upper switch and the lower switch using the LLC converter. The power converter includes the LLC converter of each of a plurality of stages in which secondary windings of the transformers are connected in series. When the output voltage is less than a threshold voltage, the power converter forms a series resonant circuit of the resonant inductor and the resonant capacitor in any one or more of the LLC converters of the plurality of stages, and performs the switching operation on another of the LLC converters.

According to example embodiments of the present invention, the range of the output voltage Vo that can be output in the operating frequency range can be widened without providing the changeover switch on the output side. The operating frequency range can be set to a narrow range near a resonance frequency, and the conversion efficiency can be improved.

The above and other elements, features, steps, characteristics and advantages of the present invention will become more apparent from the following detailed description of the example embodiments with reference to the attached drawings.

### BRIEF DESCRIPTION OF THE DRAWINGS

FIGS. 1A and 1B are diagrams illustrating an example of use of a power converter as a battery charger.

FIG. 2 is a diagram illustrating a configuration example of the power converter.

FIGS. 3A to 3D are diagrams illustrating the power converter during an independent operation.

FIG. 4 is a diagram illustrating a change in impedance.

FIG. 5 is a diagram illustrating an example of output characteristics of the power converter illustrated in FIG. 2.

FIG. 6 is a diagram illustrating a configuration example of a power converter having a three-stage configuration.

FIGS. 7A and 7B are diagrams illustrating the power converter illustrated in FIG. 6 during a two-circuit series connection operation and an independent operation.

FIG. 8 is a diagram illustrating an example of output characteristics of the power converter illustrated in FIG. 6.

FIG. 9 is a diagram illustrating a configuration example of a multiphase LLC converter.

FIG. 10 is a diagram illustrating another configuration example of the multiphase LLC converter.

FIGS. 11A and 11B are diagrams illustrating a configuration example of a conventional power converter.

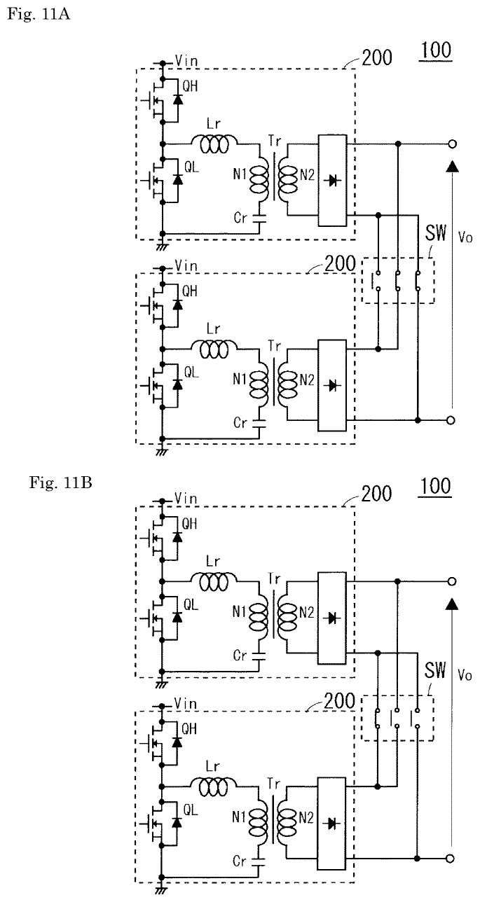

FIG. 12 is a diagram illustrating an example of output characteristics of the conventional power converter illustrated in FIGS. 11A and 11B.

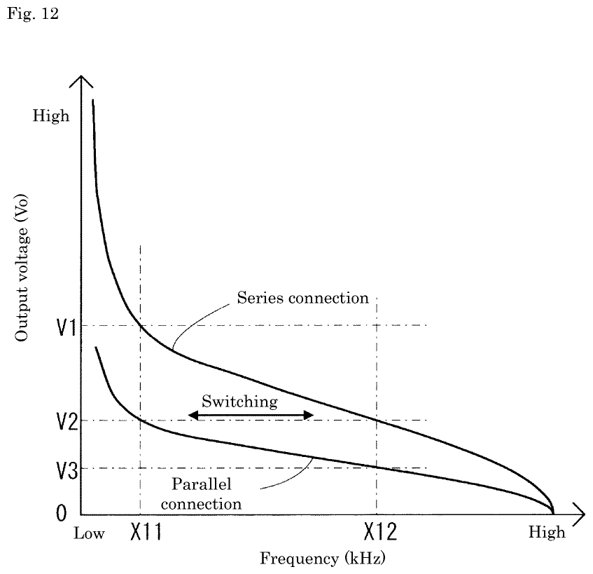

### DETAILED DESCRIPTION OF THE EXAMPLE EMBODIMENTS

Hereinafter, example embodiments of the present invention will be described in detail with reference to the drawings. In the following example embodiments, identical reference numerals are given to the configurations indicating the same functions, and the description thereof is appropriately omitted.

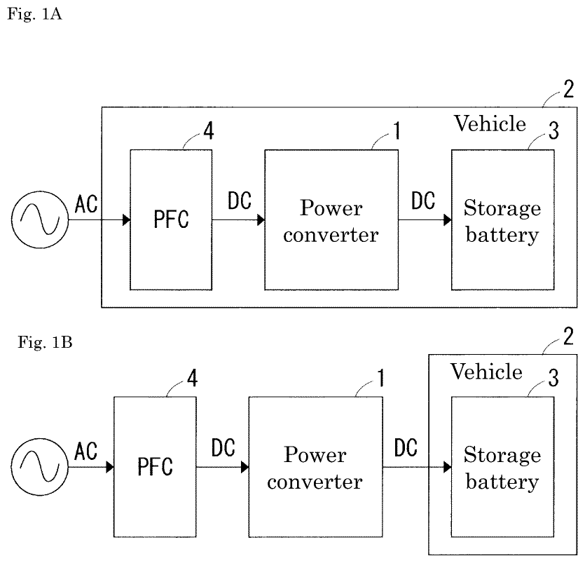

Referring to FIGS. 1A and 1B, a power converter 1 of the present example embodiment is used as a battery charger that charges a storage battery 3 (battery) mounted on a vehicle 2 such as an electric vehicle.

As illustrated in FIG. 1A, when power supplied to the vehicle 2 from outside the vehicle is an alternating-current (AC) voltage of a commercial power supply or the like, the power converter 1 is mounted on the vehicle 2 together with a PFC (power factor correction circuit) 4. The PFC 4 converts the alternating-current voltage supplied to the vehicle 2 into a direct-current (DC) voltage, and the power converter 1 converts the direct-current voltage converted by the PFC 4 into a desired output voltage to charge the storage battery 3.

As illustrated in FIG. 1B, when the power supplied to the vehicle 2 from outside the vehicle is a direct-current voltage, the power converter 1 is installed in a facility outside the vehicle 2 such as a charging station together with the PFC (power factor correction circuit) 4. The PFC 4 converts the alternating-current voltage supplied from a commercial power supply or the like into a direct-current (DC) voltage, and the power converter 1 converts the direct-current voltage converted by the PFC 4 into a desired direct-current voltage and supplies the direct-current voltage to the vehicle 2 to charge the storage battery 3.

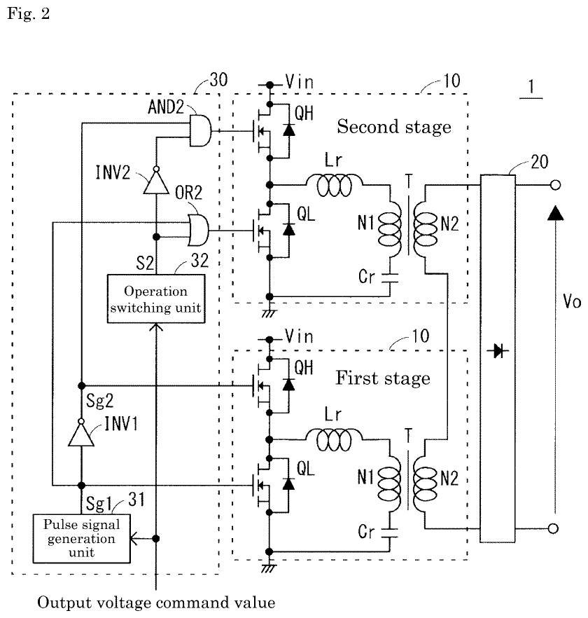

Referring to FIG. 2, the power converter 1 has a two-stage configuration including two half-bridge LLC converters (hereinafter, referred to as LLC circuits 10), and includes a rectifier 20 and a controller 30.

In the LLC circuit 10, an upper switch QH and a lower switch QL are connected in series as switching legs between a positive electrode and a negative electrode of a direct-current voltage Vin. Each of the upper switch QH and the lower switch QL includes, for example, a field-effect transistor (MOSFET: metal-oxide-semiconductor field-effect transistor). Each of the upper switch QH and the lower switch QL includes a body diode between a source and a drain. As each of the upper switch QH and the lower switch QL, a switching element such as an IGBT (Insulated Gate Bipolar Transistor), a GaN device, or a SiC (Silicon Carbide) device may be used.

The upper switch QH connected to the positive electrode of the direct-current voltage Vin is an upper arm of the switching leg. The lower switch QL connected to the negative electrode side of the direct-current voltage Vin is a lower arm of the switching leg.

The LLC circuit 10 includes a resonant inductor Lr having one end connected to a connection point between the upper switch QH and the lower switch QL. The LLC circuit 10 includes a transformer T and a resonant capacitor Cr. A primary winding N1 of the transformer T and the resonant capacitor Cr are connected in series between the other end of the resonant inductor Lr and the negative electrode of the direct-current voltage Vin.

In the transformers T of the two LLC circuits 10, secondary windings N2 are connected in series. Hereinafter, the two LLC circuits 10 in which the secondary windings N2 of the transformers T are connected in series will be referred to as the first stage and the second stage when distinguished.

The rectifier 20 rectifies an alternating current output from the secondary windings N2 connected in series, and outputs the rectified alternating current from a high-potential output terminal and a low-potential output terminal. The rectifier 20 can adopt circuit methods such as center tap rectification, bridge rectification, voltage doubler rectification, and Cockcroft-Walton rectification. In addition, the rectifier 20 can also perform synchronous rectification using an FET instead of a diode. The rectifier 20 may include an output capacitor connected between the high-potential output terminal and the low-potential output terminal. In this case, the rectifier 20 forms a rectifying and smoothing circuit together with an output capacitor Co.

The controller 30 is a semiconductor device integrated on a semiconductor substrate, and generates pulse signals Sg2 and Sg1 for driving the switching legs (the upper switches QH and the lower switches QL) of the LLC circuits 10 of the first stage and the second stage based on an output voltage command value.

The controller 30 includes a pulse signal generation unit 31 and an inverter circuit INV1. The pulse signal generation unit 31 generates the pulse signal Sg1 for driving the lower switches QL in the LLC circuits 10 of the first stage and the second stage based on the output voltage command value. The inverter circuit INV1 inverts the pulse signal Sg1 and generates the pulse signal Sg2 for driving the upper switches QH in the LLC circuits 10 of the first stage and the second stage. The pulse signal generation unit 31 decreases the output voltage Vo by increasing the switching frequency of the pulse signal Sg1 (pulse signal Sg2) and increases the output voltage Vo by decreasing the switching frequency by frequency control.

The controller 30 includes an operation switching unit 32, an OR circuit OR2, an AND circuit AND2, and an inverter circuit INV2. The operation switching unit 32 outputs a two-stage operation switching signal S2 that is at Low level when the output voltage command value is equal to or higher than a threshold voltage Vth and is at Hi level when the output voltage command value is less than the threshold voltage Vth.

In the OR circuit OR2, the pulse signal Sg1 is input to one input terminal, the two-stage operation switching signal S2 is input to the other input terminal, and an output terminal is connected to the lower switch QL in the LLC circuit 10 of the second stage. In the AND circuit AND2, the pulse signal Sg1 is input to one input terminal, the two-stage operation switching signal S2 inverted by the inverter circuit INV2 is input to the other input terminal, and an output terminal is connected to the upper switch QH in the LLC circuit 10 of the second stage.

When the output voltage command value is equal to or higher than the threshold voltage Vth, the two-stage operation switching signal S2 is at Low level. Low level is input to the other input terminal of the OR circuit OR2, and Hi level is input to the other input terminal of the AND circuit AND2. Therefore, the upper switch QH and the lower switch QL in the LLC circuit 10 of the second stage are driven by the pulse signal Sg2 and the pulse signal Sg1, respectively, similarly to the LLC circuit 10 of the first stage. The power converter 1 performs a series connection operation in which both the LLC circuits 10 of the first stage and the second stage connected in series perform a switching operation.

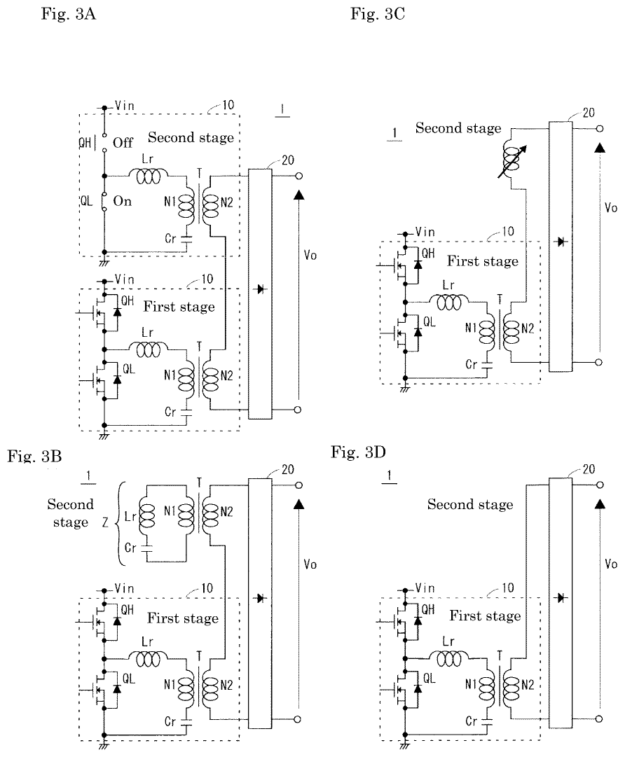

When the output voltage command value is less than the threshold voltage Vth, the two-stage operation switching signal S2 is at Hi level. Hi level is input to the other input terminal of the OR circuit OR2, and Low level is input to the other input terminal of the AND circuit AND2. Therefore, as illustrated in FIG. 3A, in the LLC circuit 10 of the second stage, the upper switch QH is in an always-off state, and the lower switch QL is in an always-on state. The power converter 1 performs an independent operation in which the LLC circuit 10 of the second stage forms a series resonant circuit of the resonant inductor Lr and the resonant capacitor Cr, and only the LLC circuit 10 of the first stage performs a switching operation.

By bringing the lower switch QL into the always-on state, the series resonant circuit of the resonant inductor Lr and the resonant capacitor Cr is formed in the LLC circuit 10 of the second stage as illustrated in FIG. 3B. An impedance Z of the series resonant circuit of the resonant inductor Lr and the resonant capacitor Cr is expressed by Equation (1) below. In Equation (1), ω is an angular frequency, and is expressed by ω=2πf using a frequency f.

$$\begin{matrix}[ Equation 1 ] & \\ Z = \vert ω Lr - \frac{1}{ω Cr} \vert = \vert 2 π f \cdot Lr - \frac{1}{2 π f \cdot Cr} \vert & ( 1 )\end{matrix}$$

The impedance Z when the angular frequency ω is ωr shown in Equation (2) below is zero as shown in Equation (3) below.

$$\begin{matrix}[ Equation 2 ] & \\ ω = ω r = \frac{1}{\sqrt{Lr \cdot Cr}} & ( 2 )\end{matrix}$$

$$\begin{matrix}[ Equation 3 ] & \\ \begin{matrix}Z = \vert ω Lr - \frac{1}{ω Cr} \vert = \vert \frac{1}{\sqrt{Lr \cdot Cr}} Lr - \frac{\sqrt{Lr \cdot Cr}}{Cr} \vert \\ = \vert \sqrt{\frac{Lr}{Cr}} - \sqrt{\frac{Lr}{Cr}} \vert = 0\end{matrix} & ( 3 )\end{matrix}$$

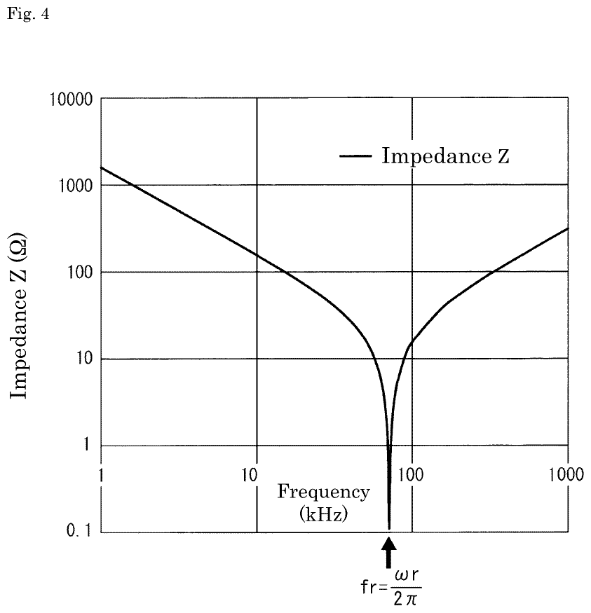

The angular frequency or at which the impedance Z is zero in this manner is referred to as a resonance angular frequency, and a resonance frequency fr is such that fr=ωr/2π. As illustrated in FIG. 4, the impedance Z increases as the switching frequency becomes farther from the resonance frequency fr.

The fact that the impedance Z changes depending on the frequency means that the impedance also changes when viewed from the secondary side of the transformer T, and as illustrated in FIG. 3C, the transformer T of the second stage can be expressed as an impedance variable equivalent circuit.

In particular, at the resonance frequency fr at which the impedance Z becomes zero, the transformer T of the second stage is short-circuited on the primary side, and the impedance also becomes zero on the secondary side as illustrated in FIG. 3D. That is, in the transformer T of the second stage, the secondary winding N2 is also equivalent to a short circuit.

Therefore, the LLC circuit 10 of the first stage performs a switching operation near the most efficient resonance frequency fr, and the LLC circuit 10 of the second stage forms the series resonant circuit of the resonant inductor Lr and the resonant capacitor Cr. Then, as illustrated in FIG. 3D, since the second stage can be regarded as being short-circuited, the power converter 1 can be regarded as only the LLC circuit 10 of the first stage. That is, it is possible without providing a changeover switch on the secondary side to switch between the series connection operation in which the LLC circuits 10 of the first stage and the second stage perform the switching operation and the independent operation in which only the LLC circuit 10 of the first stage performs the switching operation.

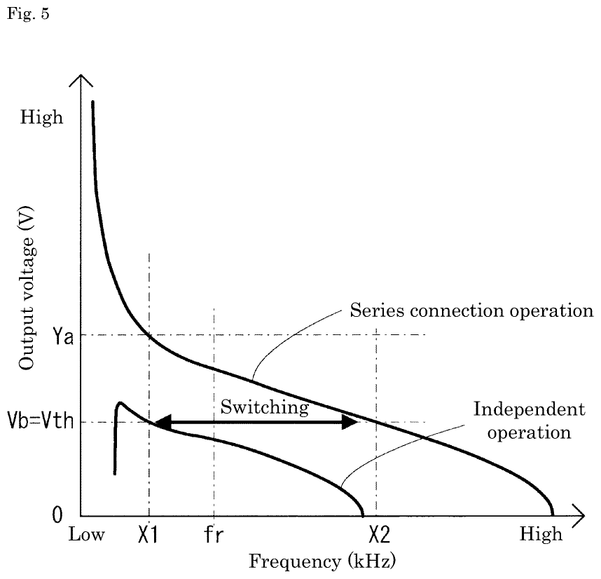

FIG. 5 is an example of output characteristics of the switching frequency and the output voltage Vo in the series connection operation and the independent operation. Referring to FIG. 5, the output voltage Vo at an identical frequency is lower in the independent operation than in the series connection operation. When X1 to X2 (X1<X2) with the resonance frequency fr therebetween is set as an operating range (hereinafter, referred to as an operating frequency range) of the switching frequency, the output voltage Vo that can be output in the operating frequency range is Va to Vb (Va>Vb) in the series connection operation. The output voltage Vo in the independent operation is ½ of that in the series connection operation near the resonance frequency fr. The output voltage Vo in the independent operation becomes lower than ½ of that in the series connection operation due to the impedance Z as the frequency goes away from the resonance frequency fr. In the independent operation, the maximum frequency at which the output voltage Vo=0 is suppressed as compared with that in the series connection operation.

By setting an appropriate threshold voltage Vth (for example, the output voltage Vo=Vb) and switching from the series connection operation to the independent operation when the voltage is less than the threshold voltage Vth, the range of the output voltage Vo that can be output in the operating frequency range is widened to the lower voltage side than the output voltage Vo=Vb.

The series resonant circuit of the resonant inductor Lr and the resonant capacitor Cr is formed with the upper switch QH being in the always-off state and the lower switch QL being in the always-on state, but may be formed with the upper switch QH being in the always-on state and the lower switch QL being in the always-off state. However, in this case, it is necessary to prepare another voltage for keeping the upper switch QH in the always-on state.

In the independent operation, the LLC circuit 10 of the first stage may be the series resonant circuit of the resonant inductor Lr and the resonant capacitor Cr, and only the LLC circuit 10 of the second stage may be caused to perform the switching operation.

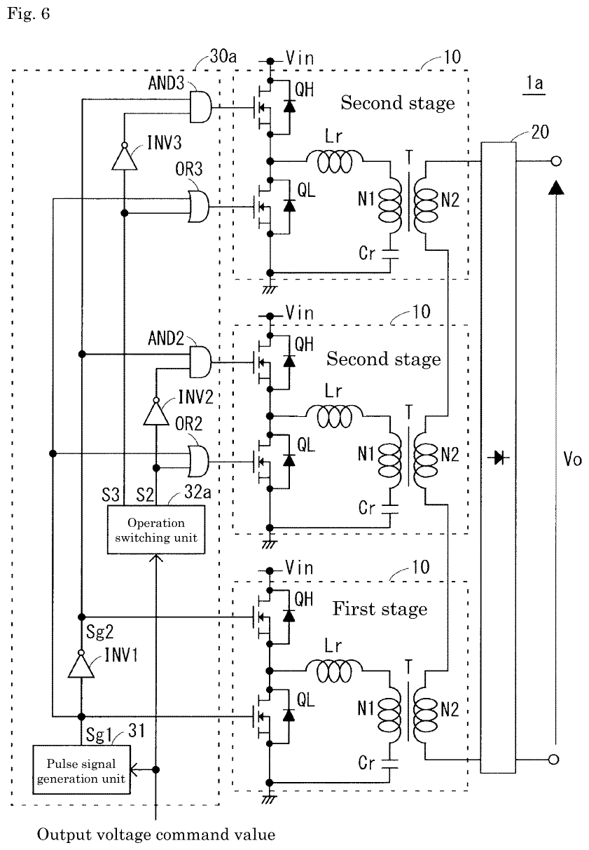

A power converter 1a illustrated in FIG. 6 has a three-stage configuration including LLC circuits 10 of three stages in which secondary windings N2 of transformers T are connected in series. The power converter 1a includes a controller 30a that drives the LLC circuits 10 of the three stages.

The controller 30a is a semiconductor device integrated on a semiconductor substrate, and generates pulse signals Sg1 and

Sg2 for driving switching legs (upper switches QH and lower switches QL) of the LLC circuits 10 of the first to third stages based on an output voltage command value.

The controller 30a includes a pulse signal generation unit 31 and an inverter circuit INV1. The pulse signal generation unit 31 generates the pulse signal Sg1 for driving the lower switches QL in the LLC circuits 10 of the first to third stages based on the output voltage command value. The inverter circuit INV1 inverts the pulse signal Sg1 and generates the pulse signal Sg2 for driving the upper switches QH in the LLC circuits 10 of the first to third stages. The pulse signal generation unit 31 decreases the output voltage Vo by increasing the switching frequency of the pulse signal Sg1 (pulse signal Sg2) and increases the output voltage Vo by decreasing the switching frequency by frequency control.

The controller 30a includes an operation switching unit 32a, OR circuits OR2 and OR3, AND circuits AND2 and AND3, and inverter circuits INV2 and INV3. The operation switching unit 32a outputs a three-stage operation switching signal S3 that is at Low level when the output voltage command value is equal to or higher than a first threshold voltage Vth1 and is at Hi level when the output voltage command value is less than the first threshold voltage Vth1. The operation switching unit 32a outputs a two-stage operation switching signal S2 that is at Low level when the output voltage command value is equal to or higher than a second threshold voltage Vth2 lower than the first threshold voltage Vth1 and is at Hi level when the output voltage command value is less than the second threshold voltage Vth2.

In the OR circuit OR3, the pulse signal Sg1 is input to one input terminal, the three-stage operation switching signal S3 is input to the other input terminal, and an output terminal is connected to the lower switch QL in the LLC circuit 10 of the third stage. In the AND circuit AND3, the pulse signal Sg1 is input to one input terminal, the three-stage operation switching signal S3 inverted by the inverter circuit INV3 is input to the other input terminal, and an output terminal is connected to the upper switch QH in the LLC circuit 10 of the third stage.

In the OR circuit OR2, the pulse signal Sg1 is input to one input terminal, the two-stage operation switching signal S2 is input to the other input terminal, and an output terminal is connected to the lower switch QL in the LLC circuit 10 of the second stage. In the AND circuit AND2, the pulse signal Sg1 is input to one input terminal, the two-stage operation switching signal S2 inverted by the inverter circuit INV2 is input to the other input terminal, and an output terminal is connected to the upper switch QH in the LLC circuit 10 of the second stage.

When the output voltage command value is equal to or higher than the first threshold voltage Vth1, the three-stage operation switching signal S3 and the two-stage operation switching signal S2 are at Low level. Low level is input to the other input terminals of the OR circuits OR3 and OR2, and Hi level is input to the other input terminals of the AND circuits AND3 and AND2. Therefore, the upper switches QH and the lower switches QL in the LLC circuits 10 of the third stage and the second stage are driven by the pulse signal Sg2 and the pulse signal Sg1, respectively, similarly to the LLC circuit 10 of the first stage. The power converter 1 performs a three-circuit series connection operation in which all the LLC circuits 10 of the first to third stages connected in series perform a switching operation.

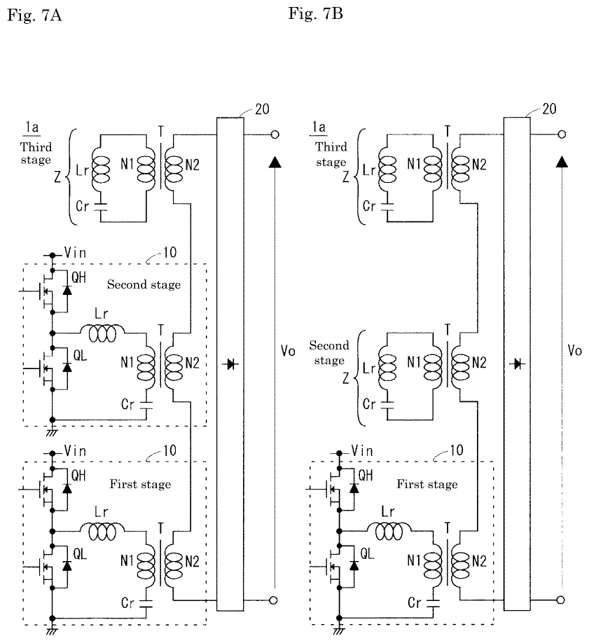

When the output voltage command value is less than the first threshold voltage Vth1 and equal to or higher than the second threshold voltage Vth2, the three-stage operation switching signal S3 is at Hi level, and the two-stage operation switching signal S2 is at Low level. Hi level is input to the other input terminal of the OR circuit OR3, and Low level is input to the other input terminal of the AND circuit AND2. Low level is input to the other input terminal of the OR circuit OR2, and Hi level is input to the other input terminal of the AND circuit AND3. Therefore, in the LLC circuit 10 of the third stage, the upper switch QH is in an always-off state, and the lower switch QL is in an always-on state. The upper switch QH and the lower switch QL in the LLC circuit 10 of the second stage are driven by the pulse signal Sg2 and the pulse signal Sg1, respectively, similarly to the LLC circuit 10 of the first stage. As illustrated in FIG. 7A, the power converter 1 performs a two-circuit series connection operation in which the LLC circuit 10 of the third stage is a series resonant circuit of a resonant inductor Lr and a resonant capacitor Cr, and the LLC circuits 10 of the first stage and the second stage connected in series perform the switching operation.

When the output voltage command value is less than the second threshold voltage Vth2, the three-stage operation switching signal S3 and the two-stage operation switching signal S2 are at Hi level. Hi level is input to the other input terminal of the OR circuit OR2, and Low level is input to the other input terminal of the AND circuit AND2. Therefore, in the LLC circuits 10 of the third stage and the second stage, the upper switches QH are in the always-off state, and the lower switches QL are in the always-on state. As illustrated in FIG. 7B, the power converter 1 performs the independent operation, in which each of the LLC circuits 10 of the third stage and the second stage is the series resonant circuit of the resonant inductor Lr and the resonant capacitor Cr, and only the LLC circuit 10 of the first stage performs the switching operation.

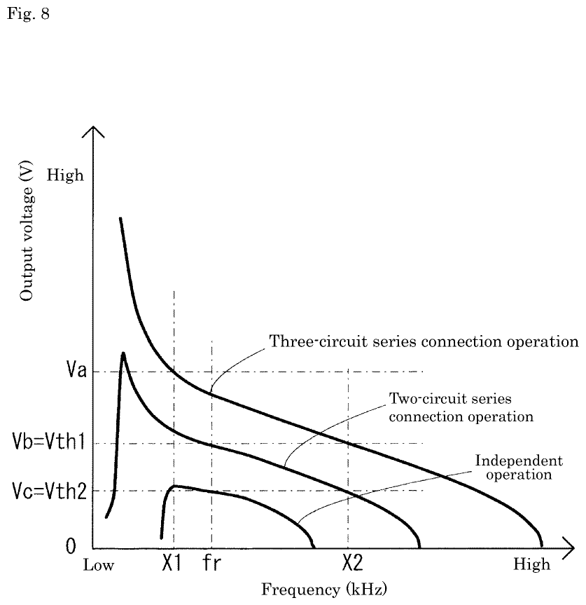

FIG. 8 is an example of output characteristics of the switching frequency and the output voltage Vo in the three-circuit series connection operation, the two-circuit series connection operation, and the independent operation. Referring to FIG. 8, at an identical frequency, the output voltage Vo is lower in the two-circuit series connection operation than in the three-circuit series connection operation, and further lower in the independent operation than in the two-circuit series connection operation. When X1 to X2 (X1<X2) with a resonance frequency fr therebetween is set as the operating range, the output voltage Vo that can be output in the operating frequency range in the three-circuit series connection operation is Va to Vb (Va>Vb) in the example illustrated in FIG. 8. The output voltage Vo in the two-circuit series connection operation is ⅔ of that in the three-circuit series connection operation near the resonance frequency fr. The output voltage Vo in the two-circuit series connection operation becomes lower than ⅔ of that in the series connection operation due to an impedance Z as the frequency goes away from the resonance frequency fr. In the two-circuit series connection operation, the maximum frequency at which the output voltage Vo=0 is suppressed as compared with that in the three-circuit series connection operation. The output voltage Vo that can be output in the operating frequency range in the two-circuit series connection operation is Vb to Vc (Vb>Vc) in the example illustrated in FIG. 8. The output voltage Vo in the independent operation is ½ of that in the two-circuit series connection operation near the resonance frequency fr. The output voltage Vo in the independent operation becomes lower than ½ of that in the two-circuit series connection operation due to two impedances Z as the frequency goes away from the resonance frequency fr. In the independent operation, the maximum frequency at which the output voltage Vo=0 is further suppressed as compared with that in the two-circuit series connection operation.

The range of the output voltage Vo that can be output in the operating frequency range is widened to the lower voltage side than the output voltage Vo=Vb by switching from the three-circuit series connection operation to the two-circuit series connection operation when the voltage is less than an appropriate first threshold voltage Vth1 (for example, the output voltage Vo=Vb). The range of the output voltage Vo that can be output in the operating frequency range is further widened to the lower voltage side than the output voltage Vo=Vc by switching from the two-circuit series connection operation to the independent operation when the voltage is less than an appropriate second threshold voltage Vth2 (for example, the output voltage Vo=Vc).

In the independent operation, only the LLC circuit 10 of either the third stage or the second stage may be operated, and the other LLC circuits 10 may be the series resonant circuit of the resonant inductor Lr and the resonant capacitor Cr. In the two-circuit series connection operation, the LLC circuit 10 of either the second stage or the first stage may be the series resonant circuit of the resonant inductor Lr and the resonant capacitor Cr, and the LLC circuits 10 of the other two stages may be caused to perform the switching operation.

The number of stages N of the LLC circuit 10 may be 4 or more. When the LLC circuit 10 is in N stages, switching can be made to N types of operations including an N-circuit series connection operation, an (N-1)-circuit series connection operation, . . . , and an independent operation.

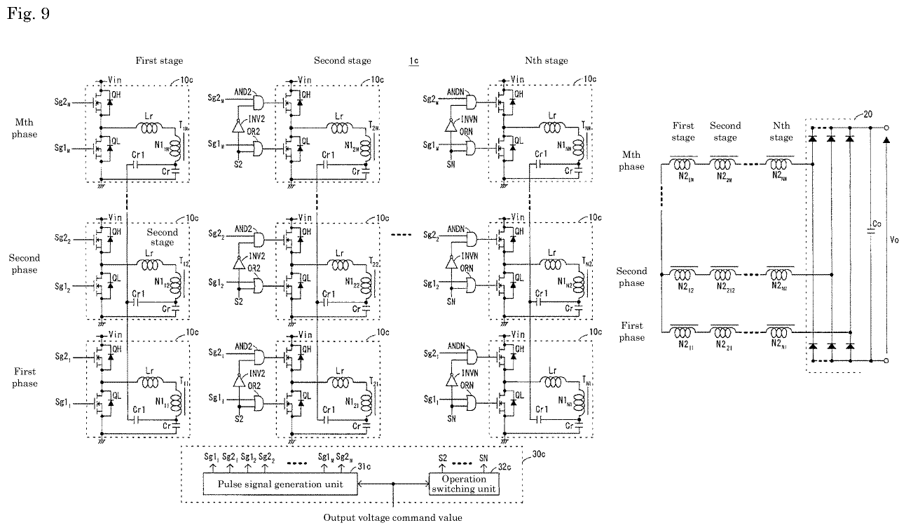

A multiphase LLC converter may be configured using the LLC circuits 10 of the N stages. A power converter 1c illustrated in FIG. 9 is an M-phase multiphase LLC converter including N×M half-bridge LLC converters (hereinafter, referred to as LLC circuits 10c). N and M are natural numbers of 2 or more.

In the power converter 1c, each phase includes the LLC circuits 10c of N stages in which secondary windings N2 of transformers T are connected in series, and the first to Mth phases are switched at a phase difference of 360°/M.

The LLC circuit 10c includes an interphase connection resonant capacitor Cr1 having one end connected to a connection point between a primary winding N1 of the transformer T and a resonant capacitor Cr, in addition to the configuration of the LLC circuit 10. The other end of the interphase connection resonant capacitor Cr1 is connected to the other end of the interphase connection resonant capacitor Cr1 included in the LLC circuit 10c of an identical stage.

The power converter 1c includes a controller 30c. The controller 30c is a semiconductor device integrated on a semiconductor substrate. The controller 30c includes a pulse signal generation unit 31c that generates pulse signals Sg21 to Sg2_{M} and Sg1₁ to Sg1_{M} for driving upper switches QH and lower switches QL of the first to Mth phases with a phase difference of 360°/M based on an output voltage command value.

The power converter 1c includes an operation switching unit 32c. The operation switching unit 32c outputs a two-stage operation switching signal S2 to an N-stage operation switching signal SN for respectively switching operations of the second stage to the Nth stage according to the output voltage command value. As for the two-stage operation switching signal S2 to the N-stage operation switching signal SN, when an n-stage operation switching signal Sn is at Low level, the LLC circuits 10c of the n (natural number of 2 to N)th stage are driven by pulse signals Sg2ₙ and Sg1ₙ similarly to the first stage. The LLC circuit 10c of the nth stage forms a series resonant circuit of the resonant inductor Lr and the resonant capacitor Cr when the n-stage operation switching signal Sn is at Hi level.

Currents flowing through secondary windings N2₁ₘ to N2_{Nm} of the first to Nth stages of the m (natural number of 1 to M)th phase are identical because the secondary windings are connected in series. That is, currents (currents in the row direction illustrated in FIG. 9) flowing through primary windings N1₁ₘ to N1_{Nm} of the first to Nth stages of the m (natural number of 1 to M)th phase are identical. Currents (currents in the column direction illustrated in FIG. 9) flowing through primary windings N1ₙ₁ to N1_{nM} of the nth stage are balanced by the interphase connection resonant capacitor Cr1. Therefore, currents are balanced in all the LLC circuits 10c.

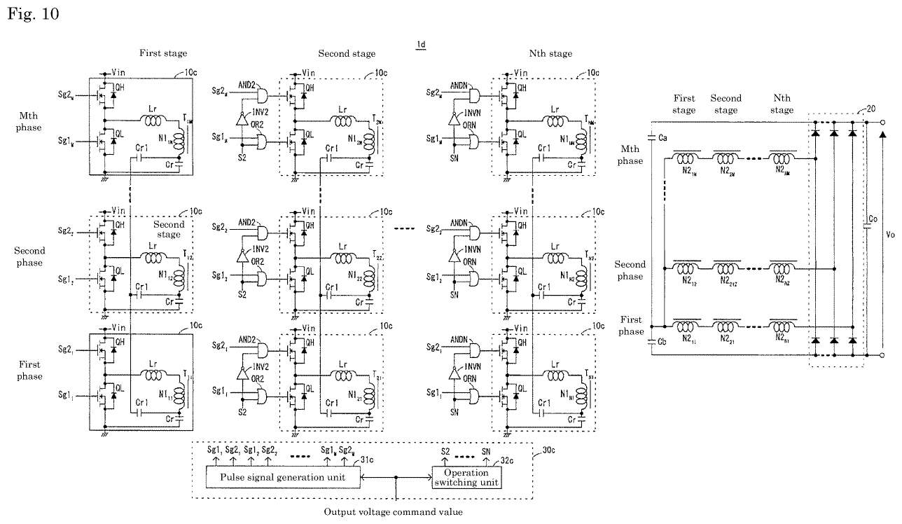

A power converter 1d illustrated in FIG. 10 includes capacitors Ca and Cb for voltage doubler rectification in addition to the configuration of the power converter 1c. Both of the capacitors Ca and Cb may be provided, or only one of them may be provided.

(1) The power converters 1, 1a, 1c, and 1d according to the example embodiments of the present invention convert the direct-current voltage Vin into the output voltage Vo using the LLC circuit 10 (LLC converter). The LLC circuit 10 includes the upper switch QH and the lower switch QL connected in series between the positive electrode and the negative electrode of the direct-current voltage Vin. The LLC circuit 10 includes the resonant inductor Lr connected to the connection point between the upper switch QH and the lower switch QL, the primary winding N1 of the transformer T, and the resonant capacitor Cr. The power converters 1, 1a, 1c, and 1d convert the direct-current voltage Vin into the output voltage Vo by the switching operation of the upper switch QH and the lower switch QL using the LLC circuit 10. The power converters 1, 1a, 1c, and 1d include the LLC circuit 10 of each of a plurality of stages in which the secondary windings N2 of the transformers T are connected in series. The power converters 1, 1a, 1c, and 1d include the controller 30 that causes the series resonant circuit of the resonant inductor Lr and the resonant capacitor Cr to be formed in any one or more of the LLC circuits 10 of the plurality of stages and causes the other LLC circuit 10 to perform the switching operation when the output voltage Vo is less than the threshold voltage Vth.

According to the power converters 1, 1a, 1c, and 1d according to (1), since the range of the output voltage Vo that can be output in the operating frequency range can be widened without providing a changeover switch on the output side, the operating frequency range can be set to a narrow range near the resonance frequency, and the conversion efficiency can be improved.

(2) In the power converters 1, 1a, 1c, and 1d according to (1), the controller 30 causes the series resonant circuit to be formed when the output voltage command value of the output voltage Vo is less than the threshold voltage Vth.

According to the power converters 1, 1a, 1c, and 1d according to (2), the operating frequency at a low-voltage output can be suppressed.

(3) In the power converters 1, 1a, 1c, and 1d according to (1) or (2), the controller 30 causes the series resonant circuit of the resonant inductor Lr and the resonant capacitor Cr to be formed by bringing one of the upper switch QH and the lower switch QL into the always-on state and the other into the always-off state.

According to the power converters 1, 1a, 1c, and 1d according to (3), the series resonant circuit of the resonant inductor Lr and the resonant capacitor Cr can be formed by simple control of the upper switch QH and the lower switch QL.

(4) In the power converters 1c and 1d of (1) to (3), a multiphase LLC converter of a plurality of phases is configured by using, as one phase, the LLC circuits 10c of the plurality of stages in which the secondary windings N2 are connected in series. The LLC circuit 10c includes the interphase connection resonant capacitor Cr1 having one end connected to the connection point between the primary winding N1 and the resonant capacitor Cr. The other end of the interphase connection resonant capacitor Cr1 is connected to the other end of the interphase connection resonant capacitor Cr1 included in the LLC circuit 10c of an identical stage.

According to the power converters 1c and 1d according to (4), the range of the output voltage Vo that can be output in the operating frequency range can be widened without providing a changeover switch on the output side, and currents can be balanced in the phases.

(5) A method for controlling the power converters 1, 1a, 1c, and 1d according to the example embodiments of the present invention is a method for controlling the power converters 1, 1a, 1c, and 1d that convert the direct-current voltage Vin into the output voltage Vo by a switching operation of the LLC circuit 10 (LLC converter). The LLC circuit 10 includes the upper switch QH and the lower switch QL connected in series between the positive electrode and the negative electrode of the direct-current voltage Vin. The LLC circuit 10 includes the resonant inductor Lr connected to the connection point between the upper switch QH and the lower switch QL, the primary winding N1 of the transformer T, and the resonant capacitor Cr. The power converters 1, 1a, 1c, and 1d convert the direct-current voltage Vin into the output voltage Vo by the switching operation of the upper switch QH and the lower switch QL using the LLC circuit 10. The power converters 1, 1a, 1c, and 1d include the LLC circuit 10 of each of a plurality of stages in which the secondary windings N2 of the transformers T are connected in series. The power converters 1, 1a, 1c, and 1d form the series resonant circuit of the resonant inductor Lr and the resonant capacitor Cr in any one or more of the LLC circuits 10 of the plurality of stages, and perform the switching operation on the other LLC circuit 10.

According to the method for controlling the power converters 1, 1a, 1c, and 1d according to (5), since the range of the output voltage Vo that can be output in the operating frequency range can be widened without providing a changeover switch on the output side, the operating frequency range can be set to a narrow range near the resonance frequency, and the conversion efficiency can be improved.

(6) A battery charger that charges the storage battery 3, in which the storage battery 3 is charged by the output voltage Vo of the power converters 1, 1a, 1c, and 1d of (1) to (4).

According to the battery charger according to (6), since the range of the output voltage Vo that can be output in the operating frequency range can be widened, the operating frequency range can be set to a narrow range near the resonance frequency, and the storage battery 3 can be efficiently charged.

(7) The vehicle 2 on which the storage battery 3 is mounted includes the power converters 1, 1a, 1c, and 1d of (1) to (4) that convert power supplied from the outside into the output voltage Vo for charging the storage battery 3.

According to the vehicle 2 according to (7), since the range of the output voltage Vo that can be output in the operating frequency range can be widened, the operating frequency range can be set to a narrow range near the resonance frequency, and the mounted storage battery 3 can be efficiently charged.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A power converter to convert a direct-current voltage into an output voltage by a switching operation of an upper switch and a lower switch using an LLC converter including the upper switch and the lower switch connected in series between a positive electrode and a negative electrode of the direct-current voltage, a resonant inductor connected to a connection point between the upper switch and the lower switch, a primary winding of a transformer, and a resonant capacitor, the power converter comprising:
the LLC converter of each of a plurality of stages in which secondary windings of the transformers are connected in series; and
a controller configured or programmed to cause a series resonant circuit of the resonant inductor and the resonant capacitor to be formed in any one or more of the LLC converters of the plurality of stages and cause another of the LLC converters to perform the switching operation.

2. The power converter according to claim 1, wherein the controller is configured or programmed to cause the series resonant circuit to be formed when an output voltage command value of the output voltage is less than a threshold voltage.

3. The power converter according to claim 1, wherein the controller is configured or programmed to cause the series resonant circuit of the resonant inductor and the resonant capacitor to be formed by bringing one of the upper switch and the lower switch into an always-on state and the other of the upper switch and the lower switch into an always-off state.

4. The power converter according to claim 1, wherein
a multiphase LLC converter of a plurality of phases is configured by using, as one phase, the LLC converters of the plurality of stages in which the secondary windings are connected in series;
the LLC converter includes an interphase connection resonant capacitor having one end connected to a connection point between the primary winding and the resonant capacitor; and
the other end of the interphase connection resonant capacitor is connected to the other end of the interphase connection resonant capacitor included in the LLC converter of an identical stage.

5. A method for controlling a power converter to convert a direct-current voltage into an output voltage by a switching operation of an upper switch and a lower switch using an LLC converter including the upper switch and the lower switch connected in series between a positive electrode and a negative electrode of the direct-current voltage, a resonant inductor connected to a connection point between the upper switch and the lower switch, a primary winding of a transformer, and a resonant capacitor, the power converter including the LLC converter of each of a plurality of stages in which secondary windings of the transformers are connected in series, the method comprising:
forming a series resonant circuit of the resonant inductor and the resonant capacitor in any one or more of the LLC converters of the plurality of stages, and performing the switching operation on another of the LLC converters.

6. A battery charger to charge a storage battery, the battery charger comprising the power converter according to claim 1 to convert the direct-current voltage into the output voltage to charge the storage battery.

7. A vehicle on which a storage battery is mounted, the vehicle comprising the power converter according to claim 1 to convert power supplied from outside the vehicle into the output voltage to charge the storage battery.
